(19) United States
(12) Patent Application Publication
(10) Pub. No.: US 2012/0066049 A1
(43) Pub. Date: Mar. 15, 2012

(54) IDENTIFIER-BASED COUPON REDEMPTION

(76) Inventors: Manickababu Muthugopalakrishnan, Fremont, CA (US); Steven R. Boal, Los Altos, CA (US); Emmanuel R. Pilli, San Bruno, CA (US); Durgamba Desaraju, Sunnyvale, CA (US); Gayathri Uday Nayak, Sunnyvale, CA (US); Sarika Singhal, San Jose, CA (US)

(21) Appl. No.: 13/244,783

(22) Filed: Sep. 26, 2011

Related U.S. Application Data
(63) Continuation of application No. 12/878,231, filed on Sep. 9, 2010.

(51) Int. Cl. G06Q 30/00

(52) U.S. Cl. 705/14.26

(57) ABSTRACT

Users may save coupon offers in association with account identifiers tied to user accounts, such as identifiers for customer loyalty cards, phones, or personal computing devices. Users may present the account identifiers, or physical items associated with the account identifier, while completing transactions. Retailers may utilize the account identifiers to determine which coupon offers have been saved in association with the corresponding user accounts. The saved coupon offers may then be applied against the transactions. Coupon offers saved in this manner may be counted as distributed for the purposes of producing a distribution count for reports or for applying distribution limits. For example, a user's request to print a coupon for a coupon offer may be denied if the coupon offer is saved in association with an account identifier associated with the user.

### PRIORITY CLAIM

This application claims benefit under 35 U.S.C. §120 as a Continuation of application Ser. No. 12/878,231, filed Sep. 9, 2010, the entire contents of which is hereby incorporated by reference for all purposes as if fully set forth herein. Applicants hereby rescind any disclaimer of claim scope in the parent application or the prosecution history thereof and advise the USPTO that the claims in this application may be broader than any claim in the parent application.

### TECHNICAL FIELD

Embodiments relate generally to coupon distribution, and, more specifically, to techniques for providing customers with access to coupon offers without printed copies of the coupon.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In general, a coupon is a certificate that entitles its holder to accept an offer described or referenced by the coupon. The offer, also subsequently referred to as the “coupon offer,” may be any type of offer, but is in general an offer by the coupon provider to provide a customer with one or more goods or services at a typically discounted price, or to provide the customer with a gift in exchange for the performance of an act, such as purchasing a good or service. A coupon often takes a “hard copy” form, such as a paper certificate, printed on which are images and/or text describing terms of the offer. The process of the user accepting a coupon offer by purchasing, contracting, or otherwise transacting with another party shall hereinafter be referred to as “redeeming” the coupon. For example, a customer may redeem a hard copy of a coupon by handing the copy to a clerk during a purchase at a retail store.

While coupons have conventionally been distributed to customers by hand, such as via mail or newspapers, recent distribution techniques now provide customers with opportunities to print their own coupons. For example, a number of websites provide search engines with which users may search for offers and then print coupons for the offers they find. Some of these websites may employ mechanisms to control the number of times that a given offer may be printed by a customer, by a device, and/or in aggregate. The printed coupons may be used in the same manner as any other coupon. However, a downside to techniques that require customers to print their own coupons is that customers may not be near a functional printer from which they can print a coupon at the time they find an offer of interest. The customer may then be unwilling or unable to take the time to access a printer before shopping.

To take advantage of coupon offers at a store, a customer must typically bring the coupons corresponding to the offers to the store. However, the planning required to ensure that the customer is carrying a coupon to which the customer is entitled when visiting a store can be greatly inconvenient, especially if the customer does not have well-structured shopping habits. Moreover, if a customer has many coupon offers to redeem, bringing the necessary coupons to a store can impose an extra burden on the customer. It may be especially difficult to organize coupons if the customer has many coupons for different stores or for different items. Even if the customer has coupons available to him at the store, sorting through coupons during a checkout can be further inconvenient to the user.

For this and other reasons, customers often do not take advantage of coupon offers to which they may be entitled. In turn, from a retailer or advertiser perspective, the value of a coupon campaign may therefore be diminished.

### BRIEF DESCRIPTION OF THE DRAWINGS

In the drawings:

FIG. 1 is a block diagram of an example system in which the techniques described herein may be practiced;

FIG. 2 is a flow chart illustrating an example method for providing a user with access to a coupon offer via a unique account identifier;

FIG. 3 is a flow chart illustrating an example method for enforcing distribution limits;

FIG. 4 depicts an example graphical user interface with which a user may view and select coupon offers;

FIG. 5 depicts an example graphical user interface with which a user may select identifiers with which to associate a selected coupon offer; and

FIG. 6 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
   2.1. Coupon Provider/Distributor
   2.2. Coupon Distribution Server
   2.3. Client
   2.4. Retailer
   2.5. Identifiers
   2.6. Variations and Alternatives
3.0. Functional Overview
   3.1. Example Transaction
   3.2. Enforcing Distribution Limits
4.0. Implementation Examples
   4.1. Campaign Distribution Parameters
   4.2. Retailer Negotiation Process
   4.3. User Interface
   4.4. Auto-Add to Card
   4.5. User Groups
   4.6. Rewards and Charitable Donations
   4.7. Coupon Expiration
5.0. Implementation Mechanism—Hardware Overview
6.0. Extensions and Alternatives

### 1.0. General Overview

Approaches, techniques, and mechanisms are disclosed for allowing users to save coupon offers in association with account identifiers tied to user accounts, such as identifiers for customer loyalty cards, phones, or personal computing devices. Users may present the account identifiers—or physical items associated with the account identifier—while completing transactions. Retailers may in turn utilize the account identifiers to determine which coupon offers have been saved to the corresponding user accounts. The saved coupon offers may then be applied against the transactions.

In an embodiment, coupon offers saved in this manner may be counted as distributed for the purposes of producing a distribution count for reporting or for applying distribution limits. For example, a user's request to print a coupon for a coupon offer may be denied if the coupon offer is at that time saved in association with an account identifier associated with the user or device. By the same token, if a user prints a coupon for the coupon offer, thus reaching a coupon distribution limit, the coupon offer may no longer be made available via account identifiers associated with the user's account.

In an embodiment, an offer is saved in association with an account identifier by means of a coupon distributor updating coupon availability data associated with the account identifier to indicate that the coupon is available to the corresponding user account. The coupon distributor may then provide the updated coupon data to one or more retailers. Based on the updated coupon data, the coupon offer may be located and redeemed during a transaction using the account identifier. For example, if the account identifier identifies a customer loyalty card or retailer-incentive credit card, the coupon distributor may provide updated coupon availability data to retailer(s) that accept the card. The retailer(s) may then update their own databases based on the coupon availability data, so as to be able to identify the associated coupon offers when the customer provides the card during a transaction. In an embodiment, after the offer has been saved and/or redeemed a specified number of times, the coupon availability data associated with the account identifier is updated to indicate that the offer is no longer available.

In an embodiment, a coupon offer is made available to multiple account identifiers associated with the same user account. For example, the offer may be made available to two different customer loyalty cards at two different retailers, assuming both customer loyalty cards have been tied to a single user account with the coupon distributor. As another example, the offer may be made available through both a credit card and a phone associated with a user account. In an embodiment, the user may select the account identifiers with which a particular coupon offer is to be made available. To simplify the description, the process of making a coupon offer available to one or more account identifiers associated with a same user account may hereinafter be referred to as saving or adding a coupon offer to the user account.

In an embodiment, a coupon offer is made available only a certain number of times per user account. For example, if a coupon offer is limited to one redemption at any given time, a customer may redeem it through a first loyalty card or a second loyalty card, but not both. To facilitate this functionality, retailers may provide the coupon distributor with coupon usage data indicating when a coupon offer associated with a particular account identifier has been redeemed. The coupon distributor may then disassociate the coupon offer from all account identifiers associated with the corresponding user account.

In an embodiment, if a coupon offer is found to be associated with an account identifier provided by a customer during a transaction, the offer is applied automatically to the transaction. Alternatively, the customer may be given a choice to redeem the coupon offer, or the customer may be required to instruct the cashier to apply the coupon offer.

In other aspects, the invention encompasses a computer apparatus and a computer-readable medium configured to carry out the foregoing steps.

### 2.0. Structural Overview

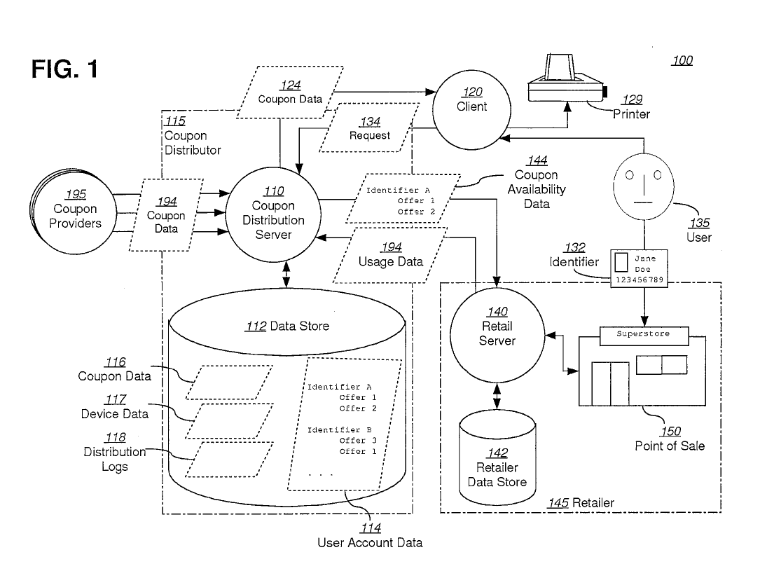

FIG. 1 is a block diagram of an example computer system 100. A coupon distribution server 110 is operated by a coupon distributor 111. The coupon distribution server 110 makes coupon offers available to users, such as user 135, on behalf of one or more coupon providers 195. Coupons may be distributed via a client 120 coupled to a printer 129 at which the coupons may be printed. Coupon offers may also be made available via user 135 requesting that the coupon offer be saved to his account, in association with one or more account identifiers. The coupon distribution server relays information about at least one identifier 132, and any offers saved in association therewith, to a retailer 145. The user may then take advantage of a coupon offer saved to his account by providing the identifier 132 at the retailer's point of sale 150.

2.1. Coupon Provider/Distributor

In an embodiment, coupon distributor 115 is any entity capable of distributing coupons on behalf of a coupon provider 195, such as a manufacturer, retailer, or advertiser. For the purposes of this application, the act of distributing a coupon may herein refer to either or both of generating a coupon and saving a coupon offer to a user account in association with one or more account identifiers. In this context, generating a coupon may include printing a coupon or creating and storing digital data representing a digital coupon. A coupon provider 195 may contract with coupon distributor 115 to distribute coupons as part of a coupon campaign. The coupon provider 195 supplies coupon distributor 115 with coupon distribution data 194 describing the coupon offer(s), as well as parameters for each coupon campaign, such as a target number of coupons to distribute in aggregate, how many coupons may be supplied to each individual end user, or start and end dates for distribution. In an embodiment, coupon distributor 115 makes coupon offers available on behalf of multiple coupon providers 195.

Coupon providers 195 may transmit coupon distribution data 194 to coupon distributor 115 electronically via a network connecting coupon provider 195 to coupon distribution server 110. For example, coupon distribution server 110 may feature a web application, file sharing, or database access component by which providers 195 may upload coupon distribution data 194 directly to coupon distribution server 110 or coupon data store 112. Coupon providers 195 may also or instead transmit coupon distribution data 194 to coupon distributor 115 by any other suitable means, including orally over a telephone.

2.2. Coupon Distribution Server

Coupon distribution server 110 is operated by a coupon distributor 115 for, among other purposes, making coupons available to users such as user 135. In an embodiment, a server may refer to one or more applications executing on one or more computers or devices that interact with counterpart client applications executing on other computers or devices. Thus, coupon distribution server 110 may be one or more server applications, executing at one or more computing devices operated by coupon distributor 115. Coupon distribution server 110 facilitates the availability of user-selected coupon offers at a point-of-sale 150 without requiring user 135 to actually present a physical coupon. Rather, coupon distribution server 110 saves information about one or more coupon offers to an identifier that the user may provide in place of a coupon when engaging in a transaction at point-of-sale 150. In an embodiment, coupon distribution server 110 is further configured for distributing printable coupons to, among other clients, client 120. However, coupon distribution server 110 need not necessarily be capable of distributing printable coupons.

Coupon distributor 115 maintains the data supplied by coupon providers 195 as coupon data 116 in data store 112, which is coupled to coupon distribution server 110. Data store 112 may comprise one or more databases and/or file repositories. Coupon data 116 may take a variety of forms, including database records and/or one or more files. Among other aspects, coupon data 116 may comprise, for each coupon offer, data such as the name of the coupon provider 195 making the coupon offer, distribution parameters, terms of the coupon offer, print layout information and graphics, one or more internal or provider identification numbers, bar code generation information, one or more relevant uniform resource locators (URLs), one or more coupon names or titles, one or more related search terms, and one or more related categories. Distribution parameters may include aggregate distribution limit values, per device distribution limit values, or per client distribution limit values.

Data store 112 further stores user account data 114. User account data 114 includes data for one or more different user accounts, each of which may or may not be mapped to a unique user. Each of the user accounts may have been established with coupon distributor 110, or may have been established with a retailer 145 and the details thereof may subsequently be communicated by the retailer 145 to coupon distributor 110. For each user account, user account data 114 specifies one or more account identifiers. Each account identifier may in turn be associated with data identifying one or more coupon offers in coupon data 116 that are available to a user. Some or all of the one or more coupon offers may also be associated with other account identifiers associated with the user account. In an embodiment, the account identifiers are associated with unique instances of each coupon offer, wherein each unique instance has a unique coupon identifier. For example, just as each coupon that may be printed by coupon distribution server 110 may have a unique coupon number, a unique coupon number may also be generated each time a user saves a coupon offer to the user's account. However, in other embodiments, user account data 114 does not require unique coupon identifiers.

Data store 112 may also store other information related to coupon distribution, including device data 117 and distribution logs 118. Device data 117 describes a plurality of devices at which clients for accessing coupon data, such as client 120, are executed. Each device may be described by a device identifier. Device data 117 may include information such as hardware identifiers, client identifiers, geographic information, and permissions data.

Distribution logs 118 track the number of coupons that have been distributed for each coupon offer described in coupon data 116, including the number of times coupons have been printed and/or the number of times coupon offers have been saved to a user account. Distribution logs 118 may further track how many times each device described in device data 117 and/or user described in user account data 114 has printed coupons for, viewed, and/or saved each coupon offer described in coupon data 116.

Coupon distribution server 110 receives and responds to coupon-related requests from client 120 over one or more networks, such as the Internet. Coupon distribution server 110 retrieves some or all of coupon data 116 to respond to various requests from client 120. For example, client 120 may request coupon distribution server 110 to provide a listing of available coupons, search for a coupon based on keywords, or save a coupon offer to the user account for user 135. In response, coupon distribution server 110 may retrieve any relevant coupon data 116 from data store 112, process the coupon data 116 as appropriate, and, based on that processing, formulate a response to the client.

Coupon distribution server 110 may be configured to control coupon distribution in a number of ways. For example, coupon distribution server 110 may be configured to deny a client permission to print the coupon, in accordance with device-based, client-based, or aggregate distribution limits. As another example, coupon distribution server 110 may be configured to deny a request 134 to save a coupon to a user account if a user has already printed a coupon from client 120. Coupon distribution server 110 may further be configured to deny a client permission to print the coupon based on geographic information associated with the client.

Coupon distribution server 110 may use distribution logs 118 for sending distribution reports 191 to coupon providers 195. The form of a report 191 may vary, and may include at least data indicating either a total number of coupons that have been distributed for a particular campaign or a total number of coupons that have been distributed for the particular campaign since the last report 191. Reports 191 may be sent at varying frequencies, and in some embodiments a report 191 may be sent each time a particular coupon is printed. Reports 191 may further include information harvested from device data 117, such as geographic information or client types of the devices to which coupons have been distributed.

2.3. Client

In an embodiment, client 120 is one or more software applications that provide user 135 with an interface to coupon distribution server 110. Client 120 may execute on any of a variety of devices, including a personal computer, printer, phone, or portable computing device. Client 120 may be, for example, a standalone software application or a web browser. Client 120 need not necessarily be executed by a device that is owned or even exclusively operated by user 135. For example, client 120 may be executed by an in-store kiosk provided to customers by retailer 145.

Client 120 communicates with coupon distribution server 110 over a network such as the Internet to receive coupon data 124. Coupon data 124 may include, for instance, a listing of information about coupons available to user 135, including offer terms and values, as well as data describing a specific coupon offer in sufficient detail to allow client 120 to print a coupon for the coupon offer at printer 129. Printer 129 is any printing device capable of printing a coupon. Printer 129 may be connected to client 120 via any communication mechanism, or client 120 may be integrated into printer 129.

Client 120 may, using various input or output mechanisms, allow user 135 to view a list of available coupon offers, select a particular coupon offer from that list, and choose whether to print a coupon for the offer, or to save the offer to user 135's account. In response to user 135 selecting the latter option, client 120 may send request 134 to coupon distribution server 110 to save the selected offer to user 135's account, as stored in user access data 114.

In an embodiment, multiple clients 120 may be available to a user, with each client 120 potentially supporting different mechanisms by which the user may access a coupon offer. For example, one client 120 may only allow a user to print coupons via printer 129, another client 120 may only allow a user to save coupon offers to an account, and another client 120 may allow a user to access coupon offers in both ways.

In an embodiment, coupon data 124 is sent from a server at an external website, such as a retail website, instead of coupon distribution server 110. In such an embodiment, request 134 may or may not be relayed through such an external website.

2.4. Retailer

Retailer 145 is any entity that conducts transactions in which users, such as user 135, may redeem coupon offers at one of retailer's point-of-sale 150 by providing an identifier, such as identifier 132. Retailer 145's point-of-sale(s) 150 may be, for example, brick-and-mortar store(s). Or, retailer 145's point-of-sale 150 may be an online website.

Coupon distribution server 110 pushes coupon availability data 144 for various account identifiers to retailer 145 via a retail server 140. For example, coupon distribution server 110 may periodically provide retail server 140 with a table of account identifiers and newly associated or disassociated coupon offers. Retail server 140 may then update retail database 142 based on the coupon availability data. Coupon distribution server 110 does not necessarily share its entire user account data 114 with retailer 145. In fact, retailer 145 may be oblivious to the concept of a user account, storing only identifiers and associated offers. Moreover, coupon distribution server 110 may only share data for certain types of identifiers with retailer 145. For instance, coupon distribution server 110 may only share data pertaining to identifiers that retailer 145 has indicated a willingness to accept (e.g. the retailer's own loyalty cards, or loyalty cards belonging to users who have been accepted into the retailer's coupon program).

Retailer 145 periodically, or in response to a transaction, reports coupon usage data 154 to coupon distribution server 110. Coupon usage data 154 indicates the redemption of one or more coupon offers, along with unique identifiers associated with the redemptions.

2.5. Identifiers

Account identifier 132 is a series of characters and/or symbols that uniquely identifies user 135 or a user account associated with user 135. For example, account identifier 132 may identify a retailer's loyalty account, a user account with coupon distributor 115, or both. In the latter case, for instance, account identifier 132 may have been created to identify the retailer's loyalty account, but then subsequently registered with the coupon distributor account, along with potentially other identifiers. Account identifier 132 may or may not also identify or be identified from a physical item, such as a card or personal computing device. In an embodiment, the physical item is any portable item that has an account identifier that can be readily accessed during a transaction.

In an embodiment, account identifier 132 is a number on a card, such as a credit card or customer loyalty card. User 135 may provide identifier 132 during a transaction by, for example, scanning the card at a card reader, typing or stating the numbers on the card, or providing personal information by which the card number may be located, such as a telephone number.

In an embodiment, account identifier 132 is a unique device identifier belonging to a mobile phone, tablet computer, personal digital assistant, flash drive, music player, camera, or other portable computing device. For example, the device identifier may be a MAC address, Bluetooth address, serial number, randomly assigned number, and so forth. User 135 may provide identifier 132 during a transaction by, for example, allowing the portable device to broadcast identifier 132 wirelessly to the retailer's checkout system, allowing the retailer to scan the device, or allowing the retailer to see or scan information displayed by the device. In an embodiment, identifier 132 does not necessarily correspond to device hardware, but may rather be provided by a software application executing on the device.

In an embodiment, account identifier 132 is emitted wirelessly by a radio-frequency identifying (RFID) chip or any other mechanism capable of transmitting signals that may be detected during a transaction with retailer 145. For example, the RFID chip may be embedded within a card, device, or other item carried by user 135.

In an embodiment, coupon distributor 110 allows user 135 to print account identifier 132, or a barcode representation thereof, on a sheet of paper. The paper may then be presented to the retailer 145 during a transaction. Using this approach, user 135 can take advantage of the techniques described herein without having to remember account identifier 132 and without having to present to the retailer 145 an identifying card or device. The paper may or may not be reusable in different transactions at the same or at a different retailer.

In an embodiment, account identifier 132 may be associated with biometric data that uniquely identifies user 135, such as a fingerprint or a retinal scan. Thus, the user may provide the identifier in an embodiment by allowing a retailer to scan user 135 for the biometric data.

2.6. Variations and Alternatives

System 100 as shown in FIG. 1 presents only one embodiment in which the techniques described herein may be practiced. Other embodiments may include additional and/or fewer elements, in potentially different arrangements. For example, in an embodiment, retailer 145 operates without a retail server 140 or retailer database 142. Instead, point-of-sale 150 communicates directly with coupon distribution server 110 to determine whether identifier 132 is associated with any coupon offers. As another example, any of coupon provider 195, coupon distributor 115, or retailer 145 may be the same entity, and various other components may therefore be omitted. Moreover, printer 129 is not necessary to practice many of the techniques described herein.

### 3.0. Functional Overview

3.1. Example Transaction

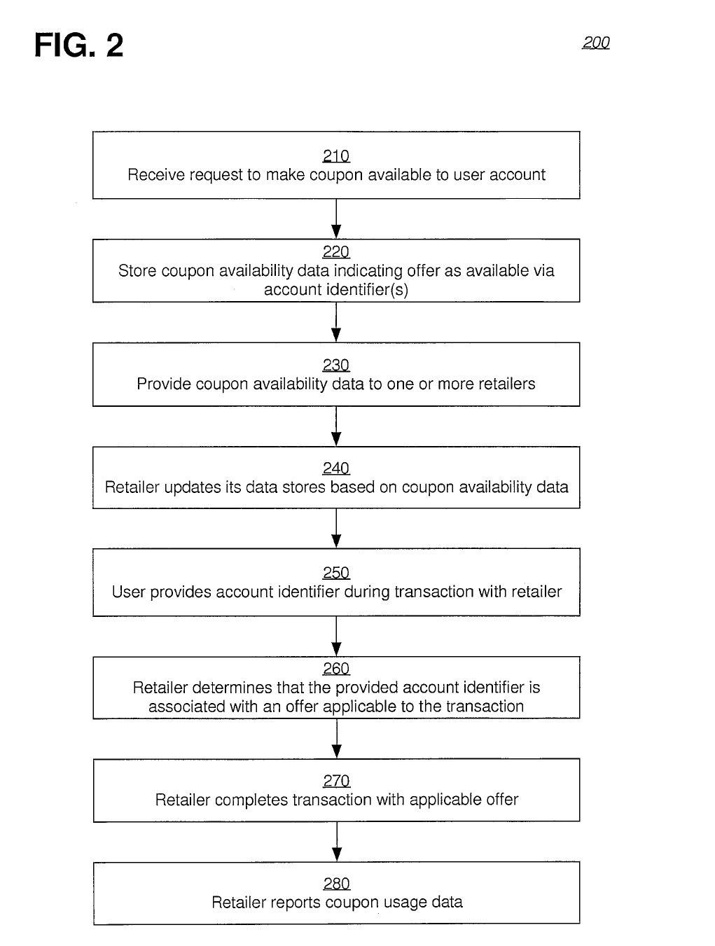

FIG. 2 is a flow chart 200 illustrating an example method for providing a user with access to a coupon offer via an account identifier.

At block 210, a coupon distribution server, such as coupon distribution server 110, receives a request indicating that a coupon offer should be made available to a user, such as user 135, via one or more account identifiers associated with the user's account. The request may or may not specify the account identifiers with which to associate the coupon offer. The request may be received as a result of input from the user at client 120. For example, the user may issue a one-time request to save a particular offer to user's account. Or, the user may issue a request to automatically and/or periodically add a category of offers to the user's account, including the particular offer.

The request may instead be received from an entity other than the user. For example, the request may be received from a retailer or a coupon provider that wishes to provide the coupon offer to the user. In such a case, the request may even have been received without the user having explicitly requested access to the coupon offer. As another example, the coupon distributor may itself request that the distribution server associate the coupon with the one or more account identifiers.

At block 220, in response to the request, the coupon distribution server stores coupon availability data indicating that the coupon offer is available via one or more identifiers associated with the user's account. The one or more identifiers may not necessarily include all of the identifiers associated with the user's account. For example, the coupon distribution server may determine that the coupon offer is not accepted by the retailer with which a certain account identifier was established, and thus not associate the coupon offer with that identifier.

The coupon distribution server may store the coupon availability data in a variety of forms in a data repository, such as data store 112. For example, the coupon distribution server may add an offer identifier or unique coupon identifier to a list of coupon offers available via an account identifiers. As another example, the coupon distribution server may add the account identifier to a list of account identifiers for which the coupon offer is available.

At block 230, further in response to the request, the coupon distribution server provides the coupon availability data to one or more retailers. In an embodiment, the coupon distribution server tailors the coupon availability data to each retailer. For example, some retailers may not recognize certain types of account identifiers, and those identifiers may therefore be removed from the coupon availability data provided to those retailers. Data may also be reformatted for the retailers, and may also include data indicating terms of a coupon offer, in the event that a retailer does not already have access to those terms.

At block 240, a retailer updates its own data stores based on the coupon availability data provided in block 230. For example, the retailer may maintain local account information associated with an account identifier. The retailer may store the coupon availability data in association with that local account information.

At block 250, the user provides an account identifier, or provides data that indicates an account identifier, during a transaction involving the retailer, such as during a purchase at a checkout register at the retailer's store. The user may provide, for example, a card on which the identifier is printed to a clerk conducting the transaction. Other techniques for providing an identifier are discussed throughout this disclosure.

At block 260, the retailer determines that the account identifier is associated with coupon availability data indicating one or more coupon offers applicable to the transaction. For example, the checkout register may communicate the identifier provided in block 250 to a central server, such as retail server 140, operated by the retailer. The central server may access coupon availability data, such as stored in block 230, to determine if any coupon offers are associated with the identifier. The central server may then analyze the terms of each coupon offer to determine if any of the coupon offers may be applied to the transaction. For example, the central server may determine that one of the coupon offers associated with the identifier is applicable to a certain product or service being purchased as part of the transaction. The central server may return information about the applicable coupon offer to the checkout register.

At block 270, the retailer completes the transaction using the one or more applicable coupon offers. For example, in accordance with terms of an applicable coupon offer, the checkout register may automatically reduce the total cost of the transaction. In an embodiment, block 270 is not necessarily automatically performed. For example, block 270 may be performed only after the user has instructed the clerk to apply the coupon offer to the transaction.

At block 280, the retailer optionally reports coupon usage data to the coupon distribution server. The coupon usage data indicates that the one or more applicable coupons have been redeemed in association with the provided account identifier.

FIG. 2 illustrates but one example of many possible embodiments. Other embodiments may feature fewer or additional steps, in potentially varying orders. For example, in an embodiment, the coupon distribution server may forego block 220 and send coupon availability data directly to one or more retailers. As another example, coupon availability data may be provided to a retailer on demand, such as when a user attempts to make a purchase. Thus, the retailer may not need to store coupon availability data locally or report coupon usage data back to the coupon distribution server.

3.2. Enforcing Distribution Limits

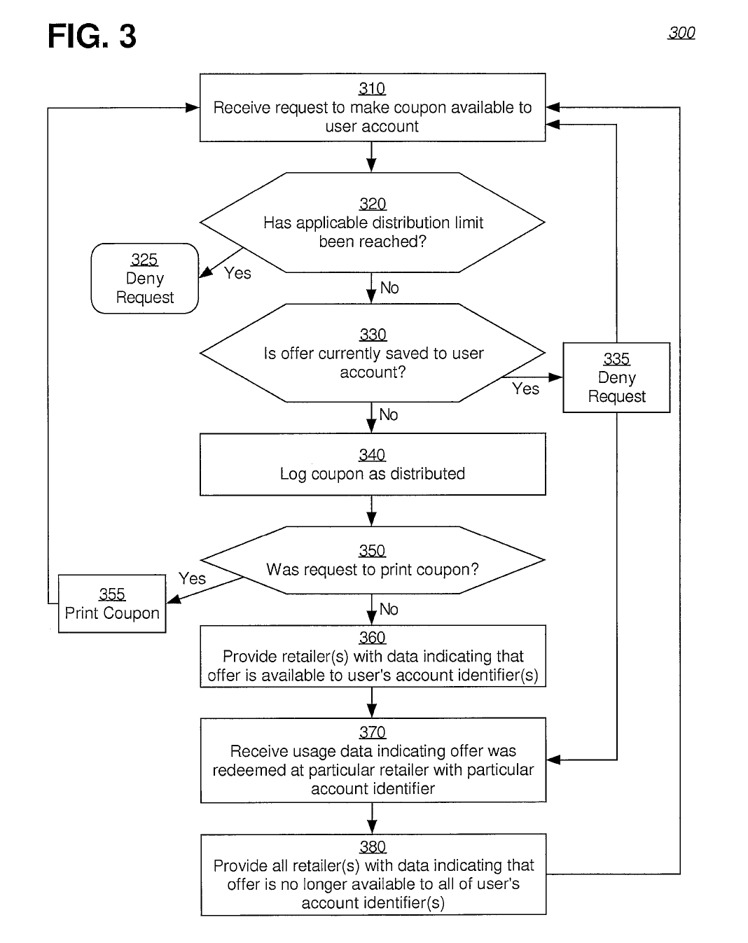

FIG. 3 is a flow chart 300 illustrating an example method for enforcing limits on the distribution of coupon offers.

At block 310, a coupon distribution server receives a request for access to a particular coupon offer. The request may be to generate a coupon for the offer by, for example, printing the coupon or generating a digital coupon. Alternatively, the request may be to save a coupon offer to a user account. The request may correspond to, for example, request 134 or the request of block 210 in FIG. 2. The request may be issued specifically for the particular coupon offer, or may be a request by the user to access multiple coupon offers, including the particular coupon offer.

At block 320, the coupon distribution server determines whether honoring the request would violate any applicable distribution limits. For example, distribution limits may be imposed on per device, per account, and/or per offer bases. The coupon server may consult data in, for example, distribution logs 118 to tally total distributions for various contexts. A distribution may be counted, for example, each time the coupon distribution server honors a request to print or save a coupon. In an embodiment, one or more distribution counts may be made with respect to a group of mutually exclusive coupon offers, as opposed to a single coupon offer. In any event, total distribution counts may then be compared to distribution limit(s) defined for various contexts, in accordance with distribution parameters established by a coupon provider, coupon distributor, and/or retailer. If an applicable distribution limit has been reached, then the request is denied at block 325. Otherwise, flow proceeds to step 330.

At block 330, the coupon distribution server determines whether the coupon offer is currently saved to the user's account. If so, then at block 335, the request is denied. Thus, for example, a user may not print a coupon while the offer is saved to the user's account. Flow may optionally then return to block 310 or proceed to block 370.

At block 340, the coupon distribution server, having determined to honor the request of block 310, logs a distribution of the coupon offer. Depending on the embodiment, the coupon distribution server 340 may instead wait for completion of block 355, block 360, or block 370 to perform this block.

Otherwise, then at block 350, the coupon distribution server branches based on the nature of the request. If the request was to generate a coupon, then at block 355, the coupon distribution server honors the request by allowing the user to print or otherwise generate a coupon based on the coupon offer. The process may optionally then return to block 310.

Otherwise, then at block 360, the coupon distribution server provides one or more retailers with data indicating that the coupon offer is available to a user presenting any of one or more account identifiers associated with the user's account. As a precursor to this step, the coupon distribution server may select the one or more account identifiers from a plurality of identifiers associated with the user account. Various filtering rules, distribution parameters, and user input may be considered in determining the one or more account identifiers with which the coupon offer may be associated.

At block 370, the coupon distribution server receives coupon usage data indicating that the coupon offer was redeemed at a first retailer by a user proving one of the one or more account identifiers. The coupon usage data may be received from any entity, including the retailer or a clearinghouse.

In response to receiving the coupon availability data of block 380, the coupon distribution server provides updated coupon availability data to all of the one or more retailers, by which the coupon distribution server disassociates the coupon offer from all of the one or more identifiers, so as to prevent the user from redeeming the coupon offer a second time using any of the one or more identifiers. Flow may then optionally return to block 310.

FIG. 3 illustrates but one example of many possible embodiments. Other embodiments may feature fewer or additional steps, in potentially varying orders. For example, in an embodiment, if a user has already saved the coupon offer to her account, the user may be allowed to print a coupon for the coupon offer, but the coupon offer is removed from the account. In an embodiment, coupon distribution limits are applied on a per-device basis. For example, a user who has printed a coupon for an offer at a first device may be prevented from adding the offer to her account from that device. However, the user may still be permitted to add the offer to her account from another device. Or, the user may still be permitted to print the offer a second time from another device. As another example, block 330 may not be necessary, as the coupon distribution server may be configured to not provide an interface for issuing the request of step 310 when the offer is already saved to the user account.

### 4.0. Implementation Examples

4.1. Campaign Distribution Parameters

Coupon providers often contract with a coupon distributor to distribute a coupon offer as part of a campaign. The campaign is defined by a number of parameters, including parameters such as distribution limits, revenue to be awarded to the distributor, and target geography.

In an embodiment, campaign parameters may include parameters related to the functionality described herein. For example, a campaign parameter may specify what number or percentage of coupons should be distributed by print as opposed to being saved to a user account. In an embodiment, the coupon provider may indicate that all or none of the coupons are to be distributed by print.

As another example, a campaign parameter may specify distribution limits per each type of identifier, so as to ensure a more equal geographic distribution. Using such a parameter, the coupon provider may, for example, limit the number of coupons that may be applied to loyalty card identifiers of a certain regional retailer. Or, by specifying a distribution limit of zero for a certain types of loyalty cards, the coupon provider may effectively block access to the coupon for certain retailers. In an embodiment, per-identifier type distribution limits may be assumed to be zero unless a coupon provider explicitly specifies a distribution parameter that targets an identifier type.

In an embodiment, a campaign parameter may specify that two or more coupon offers belong to a set of mutually exclusive coupon offers. That is, while one of the offers is saved to a user account, no other coupon offer in the set may be saved to the account. Thus, a user may be prevented from, for example, applying two coupon offers to the same product in a single transaction. The parameter may furthermore specify that, while one of the offers is saved to a user account, the user is not allowed to view and/or print any coupon offers in the set.

4.2. Retailer Negotiation Process

In an embodiment, not all offers are eligible for use at each retailer. Prior to providing some or all retailers with coupon availability data related to a particular offer, the coupon distributor first asks the retailer to approve the offer for use in transactions with the retailer in which an account identifier is specified. The coupon distribution server is configured to require this approval prior to providing coupon availability data to the retailer for the particular offer. The coupon distribution server may further include such a determination as a factor in rules for determining what coupon offers may be displayed to a user or added to the user's account.

In an embodiment, a retailer's approval of the coupon for use in transactions involving an account identifier does not imply that the retailer will accept print copies of the coupon. Likewise, a retailer's willingness to accept printed coupons for a particular offer may not necessarily imply that the retailer will allow the offer to be redeemed by a user presenting an account identifier during a checkout transaction.

4.3. User Interface

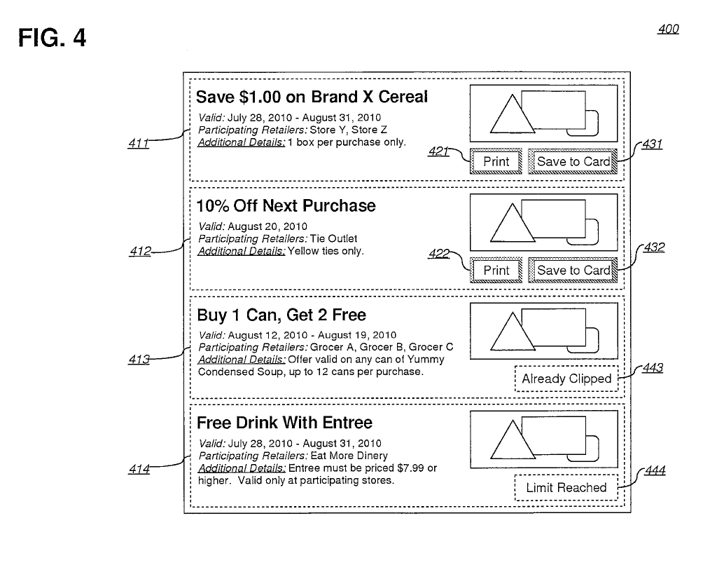

FIG. 4 depicts an example graphical user interface (GUI) 400 with which a user may view and select coupon offers.

In an embodiment, GUI 400 displays information about coupon offers 411-414. The displayed information includes controls 421-422 for printing offers 411-412 respectively. The displayed information further includes controls 431-432 for saving offers 411-412, respectively, to a user's account. There are no controls for selecting offer 413, but rather an indicator 443 that the offer 413 has already been saved to the user's account. Likewise, there are no controls for selecting offer 414, but rather an indicator 444 that the offer 414 has already reached a distribution limit.

GUI 400 may be part of, for example, a web page or application interface presented by client 120. GUI 400 may have been displayed, for example, in response to a user requesting a list of available coupons from the coupon distribution server, which request may or may not have included search parameters. Selection of the controls 421-422 or 431-432 may result in issuance of a request for a coupon, such as request 134 or the requests issued in blocks 210 or 310 of FIG. 2 and FIG. 3 respectively.

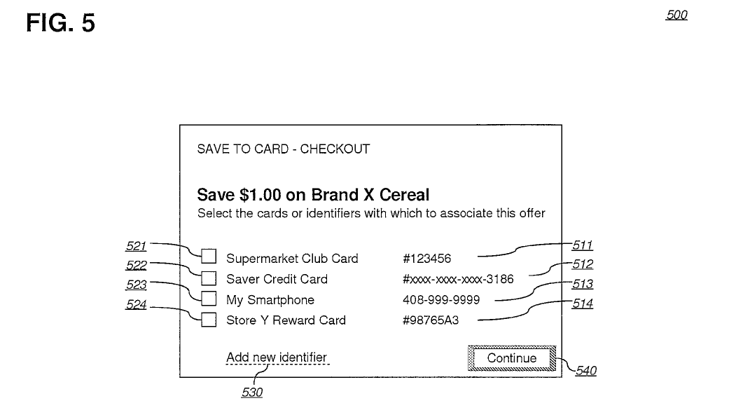

FIG. 5 depicts an example GUI 500 with which a user may select identifiers with which to associate a selected coupon offer. GUI 500 may be displayed, for example, in response to a user selecting control 431 or 432 of FIG. 4. GUI 500 comprises information about identifiers 511-514, each of which is in turn associated with one of check boxes 521-524. The information about identifiers 511-514 may have been retrieved from user account data. The identifier information may have been added to the user account data during, for example, an account configuration operation. Control 530 allows a user to add additional identifiers to his or her user account data. To select identifier(s) 511-514 with which to associate a selected offer, the user may check checkbox(es) 521-524 respectively. Selection of control 540 allows the user to proceed with the coupon request for the selected identifier(s) 511-514.

In an embodiment, the list of identifiers displayed in GUI 500 is pre-filtered to include only identifier types that are eligible for the selected offer. For example, an identifier may be omitted from GUI 500 because the coupon provider has indicated that the offer is not available for the corresponding identifier type. Or, a relevant distribution limit for the identifier may have been reached. Or, the retailer(s) that accept the identifier may not have approved the offer for use at their stores. Or, the offer may have geographic or other restrictions that preclude its use at the retailer(s) associated with the identifier.

GUIs 400 and 500 are but two examples of interfaces supporting various functionality described herein. Other interfaces in other embodiments may include fewer or additional elements in different orders. For example, GUI 400 may not include information for offers 413 or 414, owing to the user's ineligibility for those offers. In an embodiment, SMS, email, or other messaging interfaces may be used to obtain coupon listings and request that an offer be saved to the user's account.

4.4. Auto-Add to Card

In an embodiment, a coupon offer may automatically be added to a user's account on a periodic basis. For example, a user may request that a particular coupon offer be added to the user's account once a month. Or, a coupon provider may request that the coupon distributor provide this functionality as part of a campaign. If, when a new period begins, the user has not used the old coupon offer, the old coupon offer may be replaced with the new offer, the new coupon offer may be discarded, or the new coupon offer may be added to the user's account in addition to the old coupon offer. A revolving periodic distribution limit for the coupon offer may also be put into place, so that the user cannot print or add the coupon offer back to his account after redeeming it, until the period expires.

4.5. User Groups

In an embodiment, a coupon offer may be made available to a group of user accounts in response to a single request. For example, a user may request that a coupon offer be added to all user accounts associated with the user's family, such as a user account for a spouse or child. In an embodiment, when the coupon offer is used in connection with one of the user accounts in the group, the coupon offer may or may not be removed from the remaining user accounts in the group.

4.6. Rewards and Charitable Donations

In an embodiment, user account activity may trigger the awarding of rewards in a reward system. A user account may be associated with one or more reward systems. These rewards systems may be provided by coupon provider(s), the coupon distributor, and/or retailers. The user may associate the user's account with the reward systems by specifying identifiers for some or all of these reward systems when configuring the user's account. The user may also or instead be automatically enrolled in various reward systems. The user may be rewarded when the user saves or redeems coupon offers. The rewards may vary from coupon offer to coupon offer, as may the targeted reward system(s).

In an embodiment, user account activity may trigger charitable donations. For example, a user may select one or more charitable organizations to which the coupon distributor will provide donations when the user saves or redeems coupon offers. The donation amounts may vary from coupon offer to coupon offer, as may the targeted charitable organization(s).

4.7. Coupon Expiration

In an embodiment, the coupon distributor automatically removes offers that are no longer valid from a user's account, and provides retailers with updated coupon availability data reflecting such removals. Coupon offers may no longer be valid for a number of reasons, including the expiration of the time period during which the provider specified the offer to be valid and the rescission of the offer. In an embodiment, retailers check the terms of a coupon offer to ensure validity before allowing a user to redeem the offer. The retailer may furthermore pre-emotively disassociate invalid offers from identifiers. Thus, the distributor need not automatically remove invalid offers from the user's account. Nonetheless, the coupon distributor may or may not periodically remove expired or otherwise invalid coupon offers from a user account out of convenience to the user.

### 5.0. Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

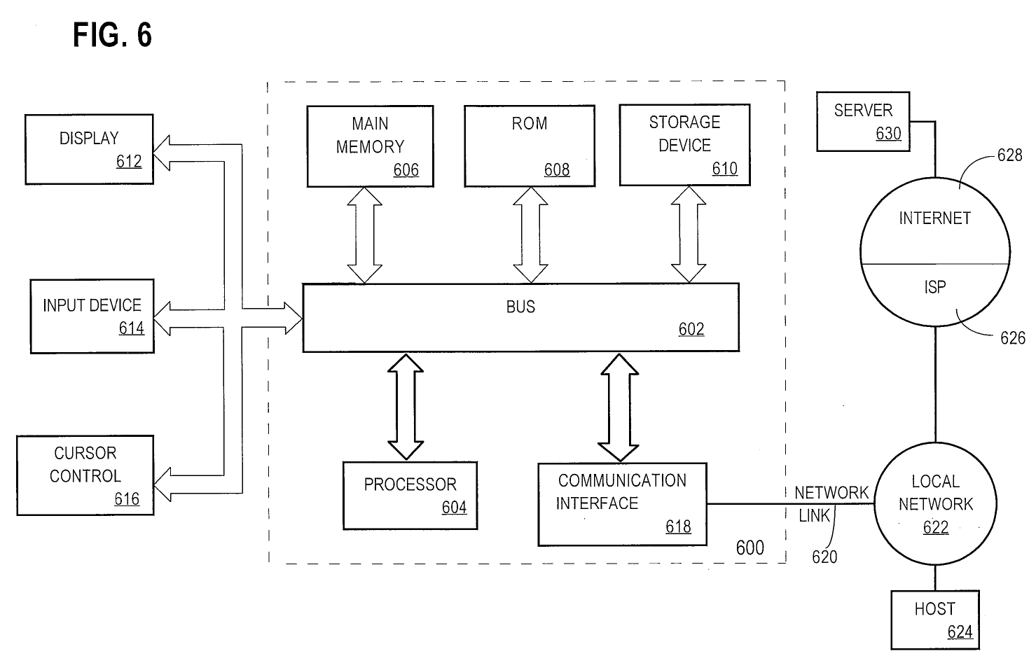

For example, FIG. 6 is a block diagram that illustrates a computer system 600. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 6.0. Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

An embodiment comprises: receiving a request to provide a user with access to a particular coupon offer; in response to the request, updating coupon availability data associated with an account identifier to indicate that the particular coupon offer is available to the user, wherein the account identifier is associated with the user; and providing the coupon availability data to a retailer with which the user may redeem the particular coupon offer using the account identifier; wherein the method is performed by one or more computing devices.

An embodiment comprises: receiving coupon usage data indicating that the user has redeemed the particular coupon offer; in response to receiving the coupon usage data, updating the coupon availability data to indicate that the particular coupon offer is no longer available to the user.

An embodiment comprises: receiving coupon usage data indicating that the user has redeemed the particular coupon offer; in response to receiving the coupon usage data, updating a distribution count for the coupon offer without updating the coupon availability data to indicate that the particular coupon offer is no longer available to the user.

An embodiment comprises: receiving a request to allow the user to print a coupon for the particular coupon offer; in response to receiving the request, determining that the particular coupon offer is already available to the user via the account identifier; in response to the determining, refusing the request to allow the user to print the coupon.

An embodiment comprises: prior to updating the coupon availability data, determining that the user has not already printed a coupon for the particular coupon offer or redeemed the particular coupon offer.

An embodiment comprises: wherein the account identifier is associated with a physical item, wherein the particular coupon offer may be redeemed by the user presenting the physical item while completing a transaction with the retailer.

An embodiment comprises: wherein the physical item is a loyalty card or a credit card.

An embodiment comprises: wherein the physical item is a phone, a personal computing device, or a radio-frequency identifying chip.

An embodiment comprises: wherein the retailer is one of a plurality of retailers, wherein providing the coupon availability data to the retailer is performed as part of providing the coupon availability data to the plurality of retailers.

An embodiment comprises: receiving coupon usage data indicating that the user has redeemed the particular coupon offer with the retailer; in response to receiving the coupon usage data, updating the coupon availability data to indicate that the particular coupon data is no longer available to the user and providing the updated coupon availability data to the plurality of retailers.

An embodiment comprises: prior to receiving the request, causing a display of information to the user about a plurality of coupon offers from different providers, wherein the request indicates user input selecting the particular coupon offer from the plurality of coupon offers.

An embodiment comprises: in response to the request, updating coupon availability data associated with a plurality of account identifiers to indicate that the particular coupon offer is available to the user; wherein the retailer is a retailer with which the user may redeem the particular coupon offer using at least one of a plurality of account identifiers.

An embodiment comprises: in response to the request, updating second coupon availability data associated with a second account identifier to indicate that the particular coupon offer is available to the user; providing the second coupon availability data to a second retailer with which the user may redeem the particular coupon offer using the second account identifier.

An embodiment comprises: receiving input specifying one or more account identifiers, including the account identifier, in association with which to make the particular coupon offer available.

An embodiment comprises: wherein, in response to the request, the steps of updating the coupon availability data and providing the coupon availability data are performed on a periodic basis.

An embodiment comprises: wherein the request to provide the user with access to the particular coupon offer is a request to automatically provide the user with access to all offers in a particular category of offers as they become available, wherein the particular coupon offer is in the particular category of offers.

An embodiment comprises: subsequent to the request, receiving a second request to provide the user with access to a second coupon offer; in response to the request: determining that the second coupon offer belongs to a particular group of coupon offers, determining that the particular group comprises the particular coupon offer, and determining that the particular coupon offer is already available to the user via the account identifier; based at least on determining that the second coupon offer belongs to the particular group of coupon offers, determining that the particular group comprises the particular coupon offer, and determining that the particular coupon offer is already available to the user via the account identifier, denying the second request.

An embodiment comprises: receiving coupon usage data indicating that the user has redeemed the particular coupon offer; in response to receiving the coupon usage data indicating that the user has redeemed the particular coupon offer, crediting an account associated with a reward system or charitable organization.

An embodiment comprises: receiving a request to provide a user with access to a particular coupon offer for a particular item; in response to the request, updating coupon availability data associated with a particular customer loyalty card to indicate that the particular coupon offer is available to the user, wherein the particular customer loyalty card is associated with an account belonging to the user; and in response to detecting a transaction involving the particular item, and in which the particular customer loyalty card is provided, identifying the particular coupon offer as available to the user for use in the transaction based on the coupon availability data; wherein the method is performed by one or more computing devices.

An embodiment comprises: automatically applying the particular coupon offer to the transaction.

An embodiment comprises: counting the particular coupon offer as distributed and producing a distribution count for one or more reports.

An embodiment comprises: counting the particular coupon offer as distributed and denying a user's request to print a coupon for a coupon offer based on the counting if the particular coupon offer has exceeded a specified distribution limit.

An embodiment comprises: one or more storage media storing instructions that, when executed by one or more computing devices, cause implementation of any of the foregoing embodiments.

What is claimed is:

1. A system comprising:
one or more computing devices that collectively implement coupon distribution server logic, the one or more computing devices coupled by one or more communication networks to retail computing devices operated by a plurality of retailers and user computing devices operated by one or more users;
a data store coupled to the one or more computing devices;
wherein the coupon distribution server logic is configured to cause performance of:
based on coupon distribution data received from a plurality of coupon providers, maintaining, in the data store, coupon data describing coupon offers for distribution via the coupon distribution server, including distribution parameters for the coupon offers;
based on the coupon data maintained in the data store, providing to the plurality of retailers terms for the coupon offers and identifiers for the coupon offers;
receiving save requests to provide digital coupons of the coupon offers;
in response to a first set of the save requests, generating in the data store user account data that associates accounts corresponding to the first set of the save requests with loyalty card identifiers and digital coupons for the coupon offers;
based on the user account data, providing to the plurality of retailers coupon availability data indicating, for each loyalty card identifier of a plurality of loyalty card identifiers, one or more digital coupons that are available for use upon the loyalty card identifier being provided in a transaction without the one or more digital coupons having been printed;
responsive to receiving, from a retailer of the plurality of retailers, coupon usage data indicating that a particular digital coupon has been used in a transaction, updating the user account data by disassociating the particular digital coupon from any loyalty card identifier with which the particular digital coupon is associated, including at least one loyalty card identifier, and sending updated coupon availability data reflecting the updated user account data to the plurality of retailers;
receiving print requests to provide printable coupons of the coupon offers;
providing one or more printable coupons in response to one or more of the print requests;
refusing to provide a printable coupon for a first coupon offer in response to at least a first request associated with a first account, based at least in part on determining that a digital coupon for the first coupon offer is, at the time of the first request, associated with the first account; and
refusing to provide a digital coupon for a second coupon offer in response to at least a second request, based at least in part on at least one of: determining that a printable coupon for the second coupon offer has been printed by a user associated with the second request, or determining that a printable coupon for the second coupon offer has been printed at a client associated with the second request.

2. The system of claim 1, wherein the coupon distribution server logic is configured to cause performance of:
subsequent to the second request, providing a printable coupon of the first coupon offer in response to a third request associated with the first account, based on determining that no digital coupon for the first coupon offer is, at the time of the third request, associated with the first account.

3. The system of claim 1, wherein the coupon distribution server logic is configured to cause performance of:
refusing to provide a printable coupon in response to at least a third request, based on determining that a third account associated with the third request has already been provided a maximum number of digital coupons and printed coupons, in aggregate, for a third coupon offer specified in the third request; and
refusing to provide a digital coupon in response to at least a fourth request, based on determining that a fourth account associated with the fourth request has already been provided a maximum number of digital coupons and printed coupons, in aggregate, for a fourth coupon offer specified in the fourth request.

4. The system of claim 1, wherein the at least one of: determining that a printable coupon for the second coupon offer has been printed by a user associated with the second request, or determining that a printable coupon for the second coupon offer has been printed at a client associated with the second request, comprises:
determining that the printable coupon for the second coupon offer has been printed within a certain period of time.

5. The system of claim 1, wherein the coupon distribution server logic is configured to cause performance of: causing, based on the coupon data, displays of information about the coupon offers, the displays including one or more interface components for requesting digital coupons or printable coupons for particular coupon offers from the coupon offers.

6. The system of claim 5, wherein at least a particular display of the displays of information do not include interface components for requesting printable coupons for the first coupon offer, based at least in part on determining that an account associated with the particular display is, at the time the particular display was requested, associated with a digital coupon for the first coupon offer.

7. The system of claim 1, wherein the coupon distribution server logic is configured to cause performance of receiving, in association with a particular save request, a selection of a first loyalty card identifier, from a plurality of loyalty card identifiers associated with a particular account, with which a requested digital coupon is to be associated.

8. The system of claim 1, wherein the distribution parameters indicate, for a same coupon offer, separate distribution parameters for digital coupons and printed coupons.

9. The system of claim 1, wherein the coupon distribution server logic is configured to cause performance of automatically associating loyalty card identifiers with digital coupon offers for any newly available coupon offer that matches one or more predefined criteria.

10. The system of claim 1, wherein the coupon distribution server logic is configured to cause performance of refusing to provide a digital coupon for a third coupon offer in response to at least a third request associated with a third account, based at least in part on determining that a digital coupon for a fourth coupon offer is, at the time of the first request, associated with the fourth account, wherein the fourth coupon offer is in a same group as the third coupon offer.

11. One or more non-transitory computer-readable media storing instructions that, when executed by one or more computing devices, cause:
based on coupon distribution data received from a plurality of coupon providers, maintaining, at a coupon distribution server, coupon data describing coupon offers for distribution via the coupon distribution server, including distribution parameters for the coupon offers;
based on the coupon data maintained at the coupon distribution server, providing to a plurality of retailers terms for the coupon offers and identifiers for the coupon offers;
receiving, at the coupon distribution server, save requests to provide digital coupons of the coupon offers;
in response to a first set of the save requests, the coupon distribution server generating user account data that associates accounts corresponding to the first set of the save requests with loyalty card identifiers and digital coupons for the coupon offers;
based on the user account data, the coupon distribution server providing to the plurality of retailers coupon availability data indicating, for each loyalty card identifier of a plurality of loyalty card identifiers, one or more digital coupons that are available for use upon the loyalty card identifier being provided in a transaction without the one or more digital coupons having been printed;
responsive to the coupon distribution server receiving, from a retailer of the plurality of retailers, coupon usage data indicating that a particular digital coupon has been used in a transaction, updating the user account data by disassociating the particular digital coupon from any loyalty card identifier with which the particular digital coupon is associated, including at least one loyalty card identifier, and sending updated coupon availability data reflecting the updated user account data to the plurality of retailers;
receiving, at the coupon distribution server, print requests to provide printable coupons of the coupon offers;
providing one or more printable coupons in response to one or more of the print requests;
refusing to provide a printable coupon for a first coupon offer in response to at least a first request associated with a first account, based at least in part on determining that a digital coupon for the first coupon offer is, at the time of the first request, associated with the first account;
refusing to provide a digital coupon for a second coupon offer in response to at least a second request, based at least in part on at least one of: determining that a printable coupon for the second coupon offer has been printed by a user associated with the second request, or determining that a printable coupon for the second coupon offer has been printed at a client associated with the second request;
wherein the method is performed by one or more computing devices.

12. The one or more non-transitory computer-readable media of claim 11, wherein the instructions, when executed by the one or more computing devices, further cause:
subsequent to the second request, providing a printable coupon of the first coupon offer in response to a third request associated with the first account, based on determining that no digital coupon for the first coupon offer is, at the time of the third request, associated with the first account.

13. The one or more non-transitory computer-readable media of claim 11, wherein the instructions, when executed by the one or more computing devices, further cause:
refusing to provide a printable coupon in response to at least a third request, based on determining that a third account associated with the third request has already been provided a maximum number of digital coupons and printed coupons, in aggregate, for a third coupon offer specified in the third request; and
refusing to provide a digital coupon in response to at least a fourth request, based on determining that a fourth account associated with the fourth request has already been provided a maximum number of digital coupons and printed coupons, in aggregate, for a fourth coupon offer specified in the fourth request.

14. The one or more non-transitory computer-readable media of claim 11, wherein the at least one of: determining that a printable coupon for the second coupon offer has been printed by a user associated with the second request, or determining that a printable coupon for the second coupon offer has been printed at a client associated with the second request, comprises:
determining that the printable coupon for the second coupon offer has been printed within a certain period of time.

15. The one or more non-transitory computer-readable media of claim 11, wherein the instructions, when executed by the one or more computing devices, further cause: causing, based on the coupon data, displays of information about the coupon offers, the displays including one or more interface components for requesting digital coupons or printable coupons for particular coupon offers from the coupon offers.

16. The one or more non-transitory computer-readable media of claim 15, wherein at least a particular display of the displays of information do not include interface components for requesting printable coupons for the first coupon offer, based at least in part on determining that an account associated with the particular display is, at the time the particular display was requested, associated with a digital coupon for the first coupon offer.

17. The one or more non-transitory computer-readable media of claim 11, wherein the instructions, when executed by the one or more computing devices, further cause receiving, in association with a particular save request, a selection of a first loyalty card identifier, from a plurality of loyalty card identifiers associated with a particular account, with which a requested digital coupon is to be associated.

18. The one or more non-transitory computer-readable media of claim 11, wherein the distribution parameters indicate, for a same coupon offer, separate distribution parameters for digital coupons and printed coupons.

19. The one or more non-transitory computer-readable media of claim 11, wherein the instructions, when executed by the one or more computing devices, further cause automatically associating loyalty card identifiers with digital coupon offers for any newly available coupon offer that matches one or more predefined criteria.

20. The one or more non-transitory computer-readable media of claim 11, wherein the instructions, when executed by the one or more computing devices, further cause refusing to provide a digital coupon for a third coupon offer in response to at least a third request associated with a third account, based at least in part on determining that a digital coupon for a fourth coupon offer is, at the time of the first request, associated with the fourth account, wherein the fourth coupon offer is in a same group as the third coupon offer.

21. A method comprising:
based on coupon distribution data received from a plurality of coupon providers, maintaining, at a coupon distribution server, coupon data describing coupon offers for distribution via the coupon distribution server, including distribution parameters for the coupon offers;
based on the coupon data maintained at the coupon distribution server, providing to a plurality of retailers terms for the coupon offers and identifiers for the coupon offers;
receiving, at the coupon distribution server, save requests to provide digital coupons of the coupon offers;
in response to a first set of the save requests, the coupon distribution server generating user account data that associates accounts corresponding to the first set of the save requests with loyalty card identifiers and digital coupons for the coupon offers;
based on the user account data, the coupon distribution server providing to the plurality of retailers coupon availability data indicating, for each loyalty card identifier of a plurality of loyalty card identifiers, one or more digital coupons that are available for use upon the loyalty card identifier being provided in a transaction without the one or more digital coupons having been printed;
responsive to the coupon distribution server receiving, from a retailer of the plurality of retailers, coupon usage data indicating that a particular digital coupon has been used in a transaction, updating the user account data by disassociating the particular digital coupon from any loyalty card identifier with which the particular digital coupon is associated, including at least one loyalty card identifier, and sending updated coupon availability data reflecting the updated user account data to the plurality of retailers;
receiving, at the coupon distribution server, print requests to provide printable coupons of the coupon offers;
providing one or more printable coupons in response to one or more of the print requests;
refusing to provide a printable coupon for a first coupon offer in response to at least a first request associated with a first account, based at least in part on determining that a digital coupon for the first coupon offer is, at the time of the first request, associated with the first account;
refusing to provide a digital coupon for a second coupon offer in response to at least a second request, based at least in part on at least one of: determining that a printable coupon for the second coupon offer has been printed by a user associated with the second request, or determining that a printable coupon for the second coupon offer has been printed at a client associated with the second request;
wherein the method is performed by one or more computing devices.

22. The method of claim 21, further comprising:
subsequent to the second request, providing a printable coupon of the first coupon offer in response to a third request associated with the first account, based on determining that no digital coupon for the first coupon offer is, at the time of the third request, associated with the first account.

23. The method of claim 21, further comprising:
refusing to provide a printable coupon in response to at least a third request, based on determining that a third account associated with the third request has already been provided a maximum number of digital coupons and printed coupons, in aggregate, for a third coupon offer specified in the third request; and
refusing to provide a digital coupon in response to at least a fourth request, based on determining that a fourth account associated with the fourth request has already been provided a maximum number of digital coupons and printed coupons, in aggregate, for a fourth coupon offer specified in the fourth request.

24. The method of claim 21, wherein the at least one of: determining that a printable coupon for the second coupon offer has been printed by a user associated with the second request, or determining that a printable coupon for the second coupon offer has been printed at a client associated with the second request, comprises:
determining that the printable coupon for the second coupon offer has been printed within a certain period of time.

25. The method of claim 21, further comprising: causing, based on the coupon data, displays of information about the coupon offers, the displays including one or more interface components for requesting digital coupons or printable coupons for particular coupon offers from the coupon offers.

26. The method of claim 25, wherein at least a particular display of the displays of information do not include interface components for requesting printable coupons for the first coupon offer, based at least in part on determining that an account associated with the particular display is, at the time the particular display was requested, associated with a digital coupon for the first coupon offer.

27. The method of claim 21, further comprising receiving, in association with a particular save request, a selection of a first loyalty card identifier, from a plurality of loyalty card identifiers associated with a particular account, with which a requested digital coupon is to be associated.

28. The method of claim 21, wherein the distribution parameters indicate, for a same coupon offer, separate distribution parameters for digital coupons and printed coupons.

29. The method of claim 21, further comprising automatically associating loyalty card identifiers with digital coupon offers for any newly available coupon offer that matches one or more predefined criteria.

30. The method of claim 21, further comprising refusing to provide a digital coupon for a third coupon offer in response to at least a third request associated with a third account, based at least in part on determining that a digital coupon for a fourth coupon offer is, at the time of the first request, associated with the fourth account, wherein the fourth coupon offer is in a same group as the third coupon offer.
